(19) United States
(12) Patent Application Publication
(10) Pub. No.: US 2026/0340808 A1
(43) Pub. Date: Oct. 29, 2026

(54) FUSION-BASED MULTIMODAL VISUAL INSPECTION FOR DEFECT DETECTION

(71) Applicant: SAP SE, Walldorf (DE)

(72) Inventors: Xinyan Chen, Singapore (SG); Ankush Mishra, Singapore (SG)

(21) Appl. No.: 19/188,943

(22) Filed: Apr. 24, 2025

(51) Int. Cl. G06T 7/00

(52) U.S. Cl. CPC G06T 7/001; G06T 2207/20081

(57) ABSTRACT

Methods, systems, and computer-readable storage media for receiving a set of multimodal training data including a first sub-set of training data of a first modality and a second sub-set of training data of a second modality, generating a first modality feature embedding and a second modality feature embedding, processing the first modality feature embedding through a first linear projector to provide a first modified modality feature embedding and the second modality feature embedding through a second linear projector to provide a second modified modality feature embedding, determining a first loss value based on the first modified modality feature embedding and the second modified modality feature embedding, determining an overall loss value, and adjusting parameters of each of the first linear projector and the second linear projector for an iteration of training based on the overall loss value for feature alignment between the first modality and the second modality.

### BACKGROUND

Defect detection is performed in manufacturing processes in an effort to ensure that defective products do not make it to market. With the development of computer vision techniques, automatic visual inspection is enabled through the user of machine learning (ML) models. For example, defect detection models can be trained on visual inspection datasets to identify classes (e.g., types) and locations of defects on products.

### SUMMARY

Implementations of the present disclosure are directed to a defect detection system for accurate identification and localization of defects in products. More particularly, implementations of the present disclosure are directed to a defect detection system that uses multiple modalities to enhance robustness and adaptability and provides comprehensive defect detection capabilities. The defect detection system of the present disclosure uses a multimodal fusion machine learning (ML) model pipeline for defect detection, classification, and localization.

receiving a set of multimodal training data including a first sub-set of training data of a first modality and a second sub-set of training data of a second modality, generating a first modality feature embedding from the first sub-set of training data and a second modality feature embedding from the second sub-set of training data, processing the first modality feature embedding through a first linear projector to provide a first modified modality feature embedding and the second modality feature embedding through a second linear projector to provide a second modified modality feature embedding, determining a first loss value based on the first modified modality feature embedding and the second modified modality feature embedding, determining an overall loss value at least partially based on the first loss value, and adjusting parameters of each of the first linear projector and the second linear projector for an iteration of training based on the overall loss value for feature alignment between the first modality and the second modality. Other implementations of this aspect include corresponding systems, apparatus, and computer programs, configured to perform the actions of the methods, encoded on computer storage devices.

These and other implementations can each optionally include one or more of the following features: actions further include aggregating the first modified modality feature embedding and the second modified modality feature embedding to provide a multimodal feature embedding, generating a unified cross-modal embedding by processing the multimodal feature embedding through a cross-modal transformer, and determining a set of predictions by processing the unified cross-modal embedding through a decoder, the set of predictions being generated by a classification head and a regression head using output of the decoder; actions further include adjusting parameters of each of the cross-modal transformer, the classification head, and the regression head for the iteration of training based on the overall loss value; the overall loss value is further determined based on a classification loss and a regression loss; the first loss value is calculated as a maximum mean discrepancy (MMD) loss that is determined based on differences between each of the first modified modality feature embedding and an average modified modality feature embedding, and the second modified modality feature embedding and the average modified modality feature embedding; the first linear projector modifies a first dimension of the first modality feature embedding to provide the first modified modality feature embedding in a common dimension, and the second linear projector modifies a second dimension of the second modality feature embedding to provide the second modified modality feature embedding in the common dimension; and the first modality includes an image modality and the second modality includes one of an ultrasound modality, a light detection and ranging (LiDAR) modality, and an ultrawide band (UWB) modality.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2A depicts an example conceptual architecture for a defect detection system in a training phase in accordance with implementations of the present disclosure.

FIG. 2B depicts an example conceptual architecture for a defect detection system in a production phase in accordance with implementations of the present disclosure.

FIGS. 3A and 3B depict example processes that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to a defect detection system for accurate identification and localization of defects in products. More particularly, implementations of the present disclosure are directed to a defect detection system that uses multiple modalities to enhance robustness and adaptability, and provides comprehensive defect detection capabilities. The defect detection system of the present disclosure uses a multimodal fusion machine learning (ML) model pipeline for defect detection, classification, and localization.

Implementations can include actions of receiving a set of multimodal training data including a first sub-set of training data of a first modality and a second sub-set of training data of a second modality, generating a first modality feature embedding from the first sub-set of training data and a second modality feature embedding from the second sub-set of training data, processing the first modality feature embedding through a first linear projector to provide a first modified modality feature embedding and the second modality feature embedding through a second linear projector to provide a second modified modality feature embedding, determining a first loss value based on the first modified modality feature embedding and the second modified modality feature embedding, determining an overall loss value at least partially based on the first loss value, and adjusting parameters of each of the first linear projector and the second linear projector for an iteration of training based on the overall loss value for feature alignment between the first modality and the second modality.

To provide further context for implementations of the present disclosure, and as introduced above, defect detection is performed in manufacturing processes in an effort to ensure that defective products do not make it to market. Defect detection can be described as the problem of identifying, categorizing, and localizing defective areas on products and is typically performed in a visual inspection phase of supply chains. Visual inspection can be described as the process of inspecting products in a production line to identify defects for quality control. Example defects can include, without limitation, surface defects (e.g., scratches, dents) and assembly defects (e.g., misaligned components, missing components) in manufacturing and automotive sectors, for example, insulator degradation in energy and utilities industry, for example, fabric tears in clothing production, for example, and the like.

With the development of computer vision techniques, automatic visual inspection is enabled through the user of machine learning (ML) models, such as deep neural networks (DNNs). Traditional defect detection systems primarily rely on visual inspection by, for example, processing images of products through a ML model to detect and localize defects. While vision-based defect detection achieves high prediction accuracy, there are several inherent limitations. For example, vision-based defect detection heavily depends on favorable lighting conditions and, as such, are unsuitable for all-day inspection scenarios. In low-light environments or nighttime conditions, inadequate illumination results in less informative images, degrading performance. As another example, vision-based defect detection captures only two-dimensional (2D) surface data, making it challenging to detect internal defects caused by structural damage or material aging, such as metal fatigue. As still another example, the effectiveness of vision-based defect detection relies on image resolution. Small defects, such as dust or scratches, may be blurred or overlooked in low-resolution images.

To address inherent limitations of vision-based approaches, such as those discussed above, incorporating additional sensing modalities can be considered. However, different modalities have limitations that need to be addressed. For example, light detection and ranging (LiDAR) can be used to generate dense point clouds that digitally represent an object's shape and operate effectively in all-day scenarios. However, laser beams of LiDAR only capture surface-level details, making it ineffective for detecting internal defects. As another example, ultrasound excels at identifying internal defects by transmitting acoustic waves through conductive materials, but provides poor localization accuracy for object detection. These limitations render unimodal solutions suitable only for specific use cases, underscoring the need for a multimodal approach.

In view of the above context, implementations of the present disclosure provide a defect detection system that uses multiple modalities to enhance robustness, adaptability, and comprehensive defect detection capabilities. As described in further detail herein, the defect detection system of the present disclosure uses a multimodal fusion ML model pipeline for defect detection, classification, and localization. The defect detection system of the present disclosure can be described as providing for one-stop defect detection that precisely localizes and identifies defective areas of products regardless of environmental conditions, defect types, and/or defect shapes. Example modalities can include an image modality (e.g., RGB images), an ultrasound modality, a LiDAR modality, and an ultra-wideband (UWB) mobility that are used by the defect detection system of the present disclosure to enable versatile defect detection. The defect detection system of the present disclosure provides a multimodal fusion framework to efficiently integrate advantages of each modality.

Implementations of the present disclosure are described in further detail with reference to an example product that includes solar panels. For example, the defect detection system of the present disclosure can be used for quality assurance by visual inspection during manufacture of solar panels to detect defects occurring in the manufacturing process. In this example, the manufacturing of solar panels can see diverse defects that can include, but are not limited to, scratches on anti-reflective coatings, crevices in metal frames, and bulges in the silicon solar cells. To inspect and locate such defects, the solar panels pass through an inspection pipeline that includes multimodal data generation representative of the solar panels. While solar panels are discussed herein for purposes of non-limiting illustration, it is contemplated, however, that implementations of the present disclosure can be realized with any appropriate product and respective process (e.g., assembly process, manufacturing process).

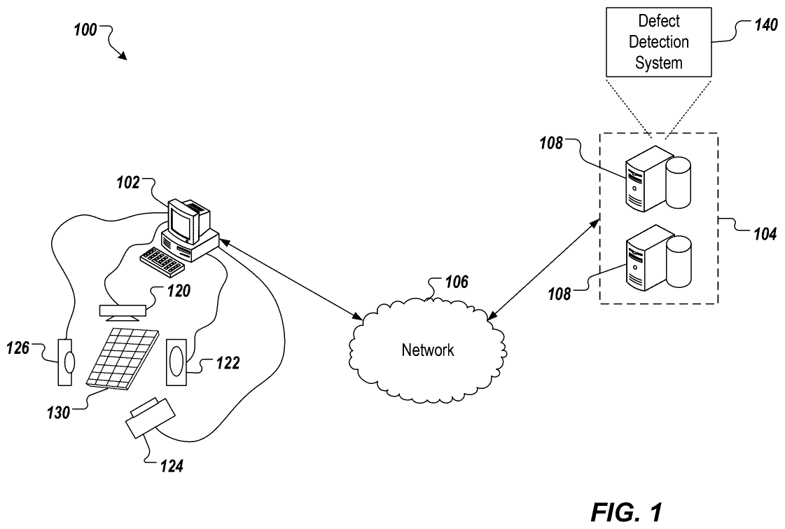

FIG. 1 depicts an example system 100 that can execute implementations of the present disclosure. The example system 100 includes a computing device 102, a back-end system 104, and a network 106. In some examples, the network 106 includes a local area network (LAN), wide area network (WAN), the Internet, or a combination thereof, and connects web sites, devices (e.g., the computing device 102), and back-end systems (e.g., the back-end system 104). In some examples, the network 106 can be accessed over a wired and/or a wireless communications link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the back-end system 104 includes at least one server system 108. In some examples, the at least one server system 108 hosts one or more computer-implemented services that users can interact with using computing devices. For example, the at least one server system 108 can host a defect detection system in accordance with implementations of the present disclosure.

In the example of FIG. 1, a camera 120, an ultrasound radar 122, a LiDAR system 124, and a UWB radar 126 are provided. As described in further detail herein, each of the camera 120, the ultrasound radar 122, the LiDAR system 124, and the UWB radar 126 generates respective data representative of a product 130 that is undergoing defect detection. Continuing with the non-limiting example above, the product 130 can be provided as a solar panel.

In some examples, the camera 120 generates images (e.g., RG B image, depth of image) representative of the product 130. In some examples, the ultrasound radar 122 generates ultrasound (US) data representative of the product 130 (e.g., a probe contacts a surface of the product 130 to transmit sound waves into the product 130 and receive reflected pulses that are converted into electrical signals as the US data). In some examples, the LiDAR system 124 generates a three-dimensional (3D) point cloud representative of the product 130 (e.g., the LiDAR system 124 emits laser pulses and measures the time of flight (ToF) of the laser pulses, calculates distances, and generates the 3D point cloud). In some examples, the UWB radar 126 generates UWB data representative of the product 130 (e.g., scans the product 130 to generate a structural imaging result showing signal amplitude versus time, which could be further interpreted into the distance between each reflecting surface and the signal transmitter).

In accordance with implementations, the data sets can be processed by a defect detection system 140 to determine whether the product 130, as represented within the data sets, includes any defects. If a defect is detected, the defect detection system 140 indicates a type of the defect and a location of the defect. In some examples, the defect detection system 140 is executed on the computing device 102. In some examples, the defect detection system 140 is executed in the back-end system 104 (e.g., as depicted in FIG. 1). As described in further detail herein, the defect detection system 140 executes a multimodal fusion ML model pipeline for defect detection, classification and localization.

As described in further detail herein, the defect detection system includes sensors of multiple modalities (e.g., camera, ultrasound radar, LiDAR, UWB radar) on, for example, a manufacturing line to collect synchronized (e.g., concurrent in time) sensing data from all of the sensors. The sensor outputs (modality-specific data) can be stored in separate modality buckets within a manufacturing operations management (MOM) platform (e.g., SAP Digital Manufacturing provided by SAP SE of Walldorf, Germany). In some examples, the modality-specific data is indexed to a product serial number of the product that is under inspection.

To process raw data from different modalities, the defect detection system includes modality-specific feature extractors that are pre-trained using large datasets from, for example, production lines. The feature extractors convert raw data into respective modality feature embeddings that represent high-level features (e.g., object shapes, pulse time intervals). In some implementations, feature alignment is executed using maximum mean discrepancy (MMD) loss to optimize linear projectors during training. The linear projectors map modality-specific features into a unified space, addressing discrepancies in scale and value distribution to enhance the effectiveness of multimodal fusion. The linear projectors provide modified modality feature embeddings that are concatenated to form a multimodal feature embedding (zₘₘ) that is fed into a cross-modal transformer. The cross-modal transformer performs attention-based multimodality fusion to generate a unified cross-modal embedding (z_{cm}), which is decoded using a decoder (e.g., transformer-based, convolution-based). Predicted labels are generated by a classification head, while the predicted bounding boxes are obtained through a regression head.

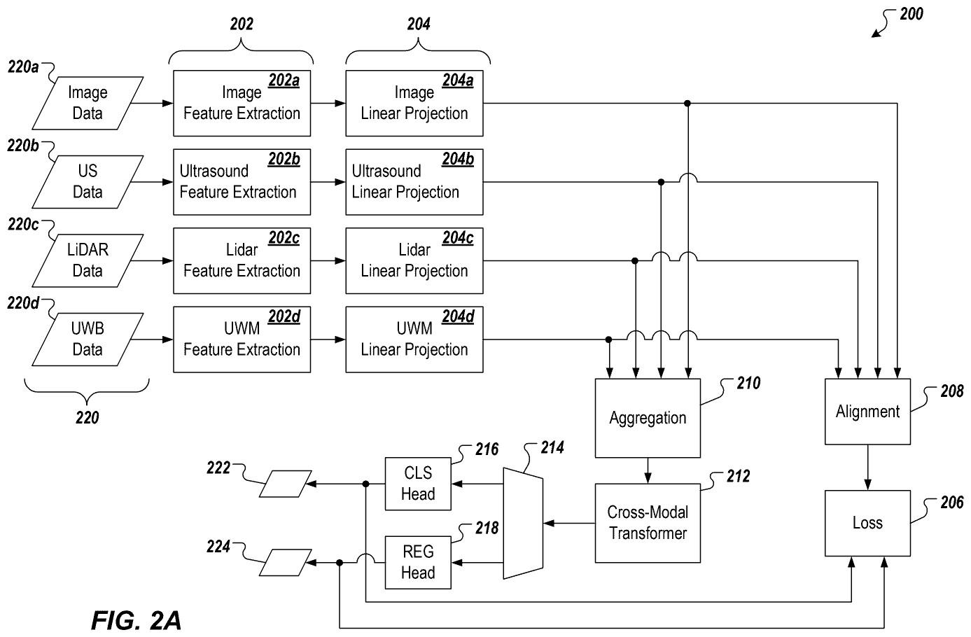

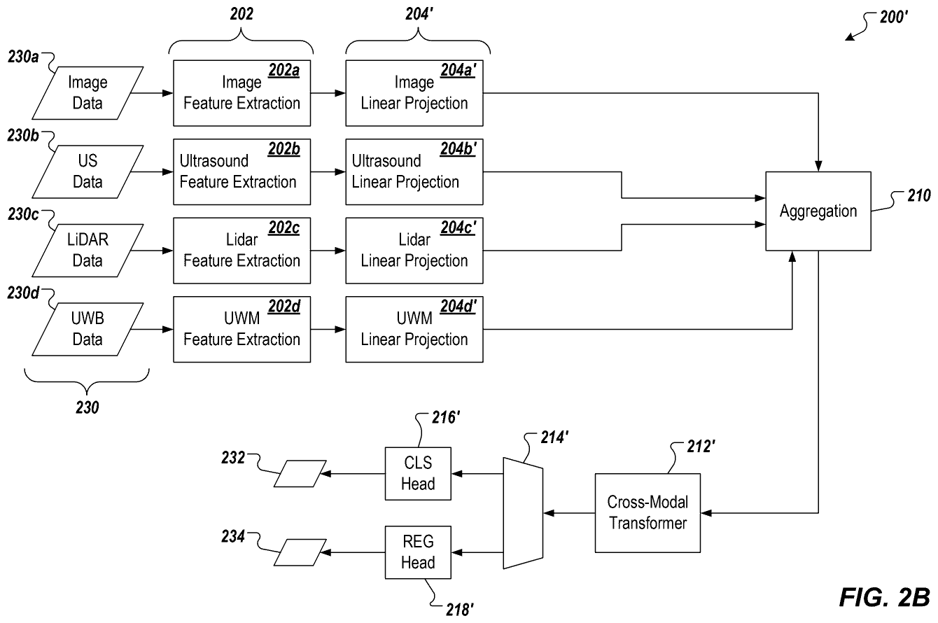

FIG. 2A depicts an example conceptual architecture 200 for a defect detection system during a training phase in accordance with implementations of the present disclosure. In the depicted example, conceptual architecture 200 includes a set of feature extraction modules 202, a set of linear projection modules 204, a loss module 206, an alignment module 208, an aggregation module 210, a cross-modal transformer 212, a decoder 214, a classification head 216, and a regression head 218.

During the training phase, sets of training data, such as a set of training data 220, are processed through multiple iterations (also referred to as epochs) of training to minimize a loss value. For an iteration, the set of training data 220 is processed to generate predictions that include a defect class and a defect location (e.g., bounding box), and a loss is determined in view of ground truth defect class and defect location for the set of training data 220. For iterations, parameters are adjusted, as described in further detail herein, in an effort to minimize the loss value. In some examples, a pre-defined number of iterations are executed. In some examples, iterations are executed until the loss achieves a threshold loss.

In further detail, to effectively extract informative high-dimensional representations from modal data, modality-specific feature extractors (having backbone structures selected based on the data structure of each modality and the characteristics of the datasets) are implemented. Accordingly, the set of feature extraction modules 202 includes a feature extraction module for each modality of a set of modalities. In the example of FIG. 2A, the set of modalities includes an image modality, an ultrasound (US) modality, a LiDAR modality, and a UWB modality. A s such, the set of feature extraction modules 202 includes an image feature extraction module 202a, an ultrasound feature extraction module 202b, a LiDAR feature extraction module 202c, and a UWB feature extraction module 202d.

In some examples, each feature extraction module is provided as a pre-trained encoder that encodes respective modality data in a respective embedding space. In some examples, the image feature extraction module 202a executes a RG B-D feature extractor provided as a pre-trained encoder from a real-time detection transformer (RT-DETR) (an object detection ML model). In some examples, the ultrasound feature extraction module 202b executes at least a portion of a pre-trained CNN-based framework, such as that discussed in Xu, et al., Medical Breast Ultrasound Image Segmentation by Machine Learning, Ultrasonics (2019) 91:1-9. doi:10.1016/j.ultras.2018.07.006, which is incorporated herein by reference. In some examples, the LiDAR feature extraction module 202c executes at least a portion of a pre-trained point transformer architecture, such as that discussed in Zhao, et al., Point Transformer, in Proceedings of the IEEE/CVF international conference on computer vision (pp. 16259-16268), which is incorporated herein by reference. In some examples, the UWB feature extraction module 202d executes at least a portion of a pre-trained deep CNN (DCNN), such as that discussed in Piriyajitakonkij, et al., SleepPoseNet: Multi-view learning for sleep postural transition recognition using UWB, IEEE Journal of Biomedical and Health Informatics, 25(4), pp. 1305-1314, which is incorporated herein by reference.

In accordance with implementations of the present disclosure, during iterations of training, sets of data, such as the set of training data 220 are processed. With particular reference to the set of training data 220, the set of training data 220 includes image data 220a, ultrasound data 220b, LiDAR data 220c, and UWB data 220d, each of which is representative of a product (e.g., a solar panel) that has a known defect at a known location. As such, for the set of training data 220, which is being used as training data, a ground truth defect type and a ground truth defect location are provided, which are used to determine loss, as described in further detail herein.

In some examples, the image data 220a is processed through the image feature extraction module 202a, which generates an image feature representation. In some examples, the image feature representation is provided as an image feature embedding, which can be described as a multi-dimensional vector representation of features represented in the image data 220a within an embedding space. In some examples, the ultrasound data 220b is processed through the ultrasound feature extraction module 202b, which generates an ultrasound feature representation. In some examples, the ultrasound feature representation is provided as an ultrasound feature embedding, which can be described as a multi-dimensional vector representation of features represented in the ultrasound data 220b within an embedding space. In some examples, the L IDA R data 220c is processed through the LiDAR feature extraction module 202c, which generates a LiDAR feature representation. In some examples, the LiDAR feature representation is provided as a LiDAR feature embedding, which can be described as a multi-dimensional vector representation of features represented in the LiDAR data 220c within an embedding space. In some examples, the UWB data 220d is processed through the UWB feature extraction module 202d, which generates an UWB feature representation. In some examples, the UWB feature representation is provided as an UWB feature embedding, which can be described as a multi-dimensional vector representation of features represented in the UWB data 220d within an embedding space.

In some examples, the embedding spaces of the image feature extraction module 202a, the ultrasound feature extraction module 202b, the LiDAR feature extraction module 202c, and the UWB feature extraction module 202d are different. Consequently, the image feature embedding, the ultrasound feature embedding, the LiDAR feature embedding, and the UWB feature embedding can be of different dimensions.

A s a note, and as implied above, because feature extractors of the feature extraction modules 202a, 202b, 202c, 202d are pre-trained on various sensor specific datasets, the extracted modality features (the feature embeddings) are not aligned in terms of scales and value distribution. As a result, the disparate feature embeddings are not effective for multimodal fusion process. In view of this, implementations of the present disclosure utilize modality-specific linear projection blocks to map features from all modalities to a common (unified) feature alignment space.

Continuing, the set of linear projection modules 204 includes a linear projection module for each modality of the set of modalities. In the example of FIG. 2A, the set of linear projection modules 204 includes an image linear projection module 204a, an ultrasound linear projection module 204b, a LiDAR linear projection module 204c, and a UWB linear projection module 204d. In some examples, each linear projection module 204a, 204b, 204c, 204d transforms a respective feature embedding to a respective modified feature embedding. M ore particularly, each feature embedding is transformed, using linear projection, from an initial dimension to a common dimension to provide a respective modified feature embedding. In this manner, all of the modified feature embeddings are of the same dimension.

In general, linear projection can be described as a process used to transform data from one embedding dimension to another using matrix multiplication with a learned weight matrix. This operation maps the input vector from an embedding space to a different embedding space and is commonly used in neural networks to adjust feature dimensions for further processing.

For example, the image feature embedding is transformed by the image linear projection module 204a from a first dimension to a modified image feature embedding having the common dimension, the ultrasound feature embedding is transformed by the ultrasound linear projection module 204b from a second dimension to a modified ultrasound feature embedding having the common dimension, the LiDAR feature embedding is transformed by the LiDAR linear projection module 204c from a third dimension to a modified LiDAR feature embedding having the common dimension, and the UWB feature embedding is transformed by the UWB linear projection module 204d from a fourth dimension to a modified UWB feature embedding having the common dimension.

In some examples, each of the linear projection modules 204a, 204b, 204c, 204d executes linear projection using a respective set of linear projection parameters. In some examples, values of each set of linear projection parameters are adjusted during the training phase. That is, and as discussed herein, between iterations of training, values of each set of linear projection parameters are adjusted responsive to a loss value. In this manner, each of the linear projection modules 204a, 204b, 204c, 204d is trained during the training phase.

Implementations of the present disclosure further provide for multimodal feature alignment using a MMD loss (L_{MMD}) that is determined based on each of the modified feature embeddings (linearly projected modality-specific features) and an averaged projected feature determined for all modalities. In general, MMD can be described as determining a distance (difference) between two distributions. In the context of the present disclosure, the distance is determined between each modified feature embedding and an average of the modified feature embeddings, and the MMD loss (L_{MMD}) is the average of these distances. This can be represented as:

$${L}_{MMD} = \frac{1}{n} {\sum }_{i = 0}^{n} MMD ( {F}_{i} , \frac{1}{n} {\sum }_{i = 0}^{n} {F}_{i} )$$

where Fᵢ is the modified feature embedding of the i^{th} modality (e.g., 1=image, 2=ultrasound, 3=LiDAR, 4=UWB). In accordance with the above equation, MMD losses for each modality are averaged to provide the MMD loss (L_{MMD}), which serves as a feature alignment optimization objective for modality-specific linear projection, as described in further detail herein.

In further detail, in some implementations, each of the modified ultrasound feature embedding, the modified ultrasound feature embedding, the modified LiDAR feature embedding, and the modified UWB feature embedding are provided to the alignment module 208. In accordance with implementations of the present disclosure, the alignment module 208 determines the MMD loss (L_{MMD}), which is provided to the loss module 206.

As described in further detail herein, implementations of the present disclosure provide for cross-modal fusion. In some examples, an objective of the training phase is to learn a unified cross-modal feature through a modality fusion structure that fully leverages informative features of each modality and effectively achieve information interaction among diverse modal features. In view of this, implementations of the present disclosure use a transformer-based structure that includes a self-attention mechanism to equally learn long-distance dependencies between any two modal features in the input, thereby effectively modeling global information for all modal features.

In further detail, and with continued reference to FIG. 2A, the modified ultrasound feature embedding, the modified ultrasound feature embedding, the modified LiDAR feature embedding, and the modified UWB feature embedding are provided to the aggregation module 210, which aggregates the modified feature embeddings to provide a multimodal feature embedding (zₘₘ). In some examples, the aggregation module 210 concatenates the modified feature embeddings (the modality-specific features) to provide the multimodal feature embedding (zₘₘ).

In some implementations, the multimodal feature embedding (zₘₘ) is provided to the cross-modal transformer 212, which generates a unified cross-modal embedding (z_{cm}). M ore particularly, and in some examples, the cross-modal transformer 212 linearly maps the multimodal feature embedding (zₘₘ) into a set of vectors {Qₘₘ, Kₘₘ, Vₘₘ}. In some examples, the cross-modal transformer 212 performs dot-product-based multi-head attention to calculate an attention value that models dependencies among modality features. In some examples, a residual connection is added to avoid gradient explosion. This results in a value oₘₘ, which represents the intermediate output between the multi-head attention module and the feed-forward network module. For example, oₘₘ can be determined as:

oₘₘ=AvgPool(MultiHead(Qₘₘ,Kₘₘ,Vₘₘ))+AvgPool(zₘₘ)

In some examples, oₘₘ is input to a feed-forward structure of the cross-modal transformer 212 with a residual connection to obtain the unified cross-modal embedding (z_{cm}). For example, the unified cross-modal embedding (z_{cm}) can be determined as:

z_{cm}=FFN(oₘₘ)+oₘₘ

In some implementations, the unified cross-modal embedding z_{cm} is provided as input to the decoder 214. In general, the decoder 214 receives the encoded features, in the form of the unified cross-modal embedding z_{cm}, and a set of learned object queries. Each object query guides the decoder 214 to focus on different aspects of the unified cross-modal embedding z_{cm}, such as refining it for tasks like bounding box prediction. The decoder 214 processes these inputs through multiple layers and outputs a set of embeddings—one per object query. In some implementations, two object queries are used to refine the unified cross-modal embedding z_{cm}. This results in two output embeddings from the decoder 214. These refined embeddings are used as inputs to the classification head 216 and the regression head 218, respectively.

In some implementations, the classification head 216 processes the output of the decoder 214 to provide a predicted class label (yₚ) 222 and the regression head 218 processes the output of the decoder 214 to provide a predicted localization (boxₚ) 224.

During the training phase, for an iteration, the predicted class label (yₚ) and the predicted localization (boxₚ) are compared to the ground truth class label (y_{gt}) and the predicted localization (box_{gt}) (e.g., ground truths of the set of training data 220), to determine respective losses. The respective losses can include a classification loss (L_{cls}) and a regression loss (L_{reg}), which can be represented as:

L_{cls}=CrossEntropyLoss(yₚ,y_{gt})

L_{reg}=MSE(boxₚ,box_{gt})

Here, the classification loss (L_{cls}) is determined as a cross-entropy loss and the regression loss (L_{reg}) is determined as a mean squared error (MSE) loss. In some examples, the loss module 206 determines the classification loss (L_{cls}) and the regression loss (L_{reg}).

Considering there are multiple losses calculated for different objectives (e.g., alignment, classification, bounding box), multiple hyperparameters α, β, γ are assigned to weight corresponding loss values when computing an overall loss (L) to balance the optimization objectives when optimizing the overall framework. In some examples, the overall loss (L) is determined as:

L=α*L_{MMD}+β*L_{cls}+γ*L_{reg}

As discussed above, during the training phase, iterations (epochs) of training are performed in an effort to minimize the overall loss (L). Between iterations, parameters of one or more of each of the linear projection modules 204a, 204b, 204c, 204d, the cross-modal transformer 212, the decoder 214, the classification head 216, and the regression head 218 are adjusted for alignment and predictions and assessing loss in the next iteration. In some examples, according to the principle of backpropagation, each loss is computed based on the model's output, and it only updates the parameters that were involved in producing that specific output. In other words, only the parts of the model that contributed to the output will receive gradients and be updated during training. For example, the MMD loss is only used to adjust the parameters in 202 and 204. The classification and regression loss will contribute to adjusting the entire-model parameters.

FIG. 2B depicts an example conceptual architecture 200′ for a defect detection system during a production phase in accordance with implementations of the present disclosure. In the depicted example, conceptual architecture 200′ includes a set of feature extraction modules 202, a set of linear projection modules 204′ (i.e., the set of linear projection modules 204 of FIG. 2A, after training), the aggregation module 210, a cross-modal transformer 212′ (i.e., the cross-modal transformer 212 of FIG. 2A, after training), a decoder 214′ (i.e., the decoder 214 of FIG. 2A, after training), a classification head 216′ (i.e., the classification head 216 of FIG. 2A, after training), and a regression head 218′ (i.e., the regression head 218 of FIG. 2A, after training). In some examples, the production phase can be described as production use of the (trained) data detection system for detecting, classifying, and localizing defects during a real-world process (e.g., manufacturing, assembly). As such, neither the loss module 206 nor the alignment module 208 are provided in the conceptual architecture 200′.

During the production phase, a set of inference data 230 is received, which includes multimodal data representative of a product. For example, the set of inference data 230 includes image data 230a, ultrasound data 230b, LiDAR data 230c, and UWB data 230d representative of a product. By way of non-limiting example, the set of inference data 230 can be representative of the product 130 of FIG. 1 and can be generated using the camera 120, the ultrasound radar 122, the LiDAR system 124, and the UWB radar 126.

In some implementations, the image data 230a, the ultrasound data 230b, the LiDAR data 230c, and the UWB data 230d are respectively processed by the image feature extraction module 202a, the ultrasound feature extraction module 202b, the LiDAR feature extraction module 202c, and the UWB feature extraction module 202d of the set of feature extraction modules 202 to respectively provide an image feature embedding, an ultrasound feature embedding, a LiDAR feature embedding, and a UWB feature embedding. In some examples, the image feature embedding, the ultrasound feature embedding, the LiDAR feature embedding, and the UWB feature embedding are respectively input to an image linear projection module 204a′, an ultrasound linear projection module 204b′, a LiDAR linear projection module 204c′, and an UWB linear projection module 204d′ of the set of linear projection modules 204′ to respectively provide a modified image feature embedding, a modified ultrasound feature embedding, a modified LiDAR feature embedding, and a modified UWB feature embedding.

In some implementations, the modified image feature embedding, the modified ultrasound feature embedding, the modified LiDAR feature embedding, and the modified UWB feature embedding are input to the aggregation module 210, which aggregates (e.g., concatenates) the modified image feature embedding, the modified ultrasound feature embedding, the modified LiDAR feature embedding, and the modified UWB feature embedding to provide a multimodal feature embedding (zₘₘ). The multimodal feature embedding (zₘₘ) is input to the cross-modal transformer 212′, which processes the multimodal feature embedding (zₘₘ) to provide a unified cross-modal embedding (z_{cm}) that is input to the decoder 214′. Output of the decoder 214′ is input to the classification head 216′ and the regression head 218′, which respectively provide a predicted class label (yₚ) 232 and a predicted localization (boxₚ) 234.

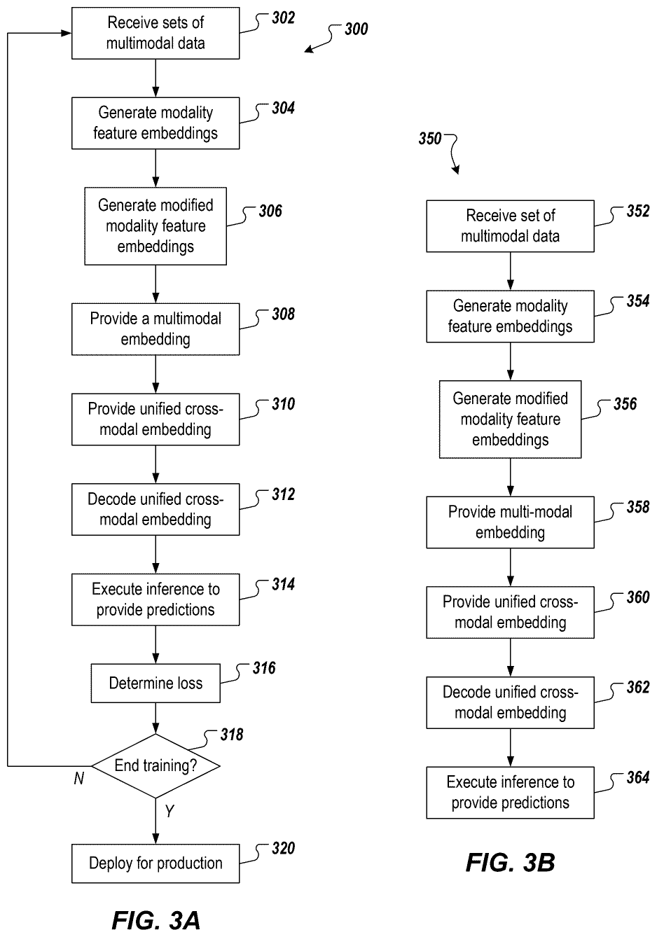

FIG. 3A depicts an example process 300 that can be executed in accordance with implementations of the present disclosure. In some examples, the example process 300 is provided using one or more computer-executable programs executed by one or more computing devices and is executed during the training phase.

Sets of multimodal data are received (302) and modality feature embeddings are generated (304). For example, and as described in further detail herein with reference to FIG. 2A, the set of training data 220 is received (e.g., from a MOM platform) and includes image data 220a, ultrasound data 220b, LiDAR data 220c, and UWB data 220d, each of which is representative of a product (e.g., a solar panel) that has a known defect at a known location. The image data 220a is processed through the image feature extraction module 202a, which generates an image feature embedding, the ultrasound data 220b is processed through the ultrasound feature extraction module 202b, which generates an ultrasound feature embedding, the LiDAR data 220c is processed through the LiDAR feature extraction module 202c, which generates a LiDAR feature embedding, and the UWB data 220d is processed through the UWB feature extraction module 202d, which generates an UWB feature embedding.

Modified modality feature embeddings are generated (306) and a multimodal embedding is provided (308). For example, and as described in further detail herein, the image feature embedding is transformed by the image linear projection module 204a to a modified image feature embedding, the ultrasound feature embedding is transformed by the ultrasound linear projection module 204b to a modified ultrasound feature embedding, the LiDAR feature embedding is transformed by the LiDAR linear projection module 204c to a modified LiDAR feature embedding, and the UWB feature embedding is transformed by the UWB linear projection module 204d to a modified UWB feature embedding having the common dimension. The modified ultrasound feature embedding, the modified ultrasound feature embedding, the modified LiDAR feature embedding, and the modified UWB feature embedding are provided to the aggregation module 210, which aggregates the modified feature embeddings to provide a multimodal feature embedding (zₘₘ).

A unified cross-modal embedding is provided (310) and is decoded (312). For example, and as described in further detail herein, the multimodal feature embedding (zₘₘ) is provided to the cross-modal transformer 212, which generates a unified cross-modal embedding (z_{cm}). The unified cross-modal embedding z_{cm} is provided as input to the decoder 214, which provides output to the classification head 216 and the regression head 218. Inference is executed to provide predictions (314) and a loss is determined (316). For example, and as described in further detail herein, the classification head 216 processes the output of the decoder 214 to provide a predicted class label (yₚ) 222 and the regression head 218 processes the output of the decoder 214 to provide a predicted localization (boxₚ). In some examples, for multimodal feature alignment, a MMD loss (L_{MMD}) that is determined based on each of the modified feature embeddings (linearly projected modality-specific features) and an averaged projected feature determined for all modalities. A classification loss (L_{cls}) is determined based on the predicted class label (yₚ) and a respective ground truth class label (y_{gt}), and a regression loss (L_{reg}) is determined based on the predicted localization (boxₚ) and a respective ground truth localization (box_{gt}). A n overall loss (L) is determined based on the MMD loss (L_{MMD}), the classification loss (L_{cls}), and the regression loss (L_{reg}).

It is determined whether training is to end (318). For example, and as described in further detail herein, it is determined whether a predefined number of iterations (epochs) of training have been executed or the overall loss (L) has achieved a threshold. If training is not to end, parameters of the linear projectors, the cross-modal transformer, the classification head, and the regression head are adjusted, and a next iteration of training is executed. If training is to end, the multimodal fusion ML model pipeline is deployed for production (320).

FIG. 3B depicts an example process 350 that can be executed in accordance with implementations of the present disclosure. In some examples, the example process 350 is provided using one or more computer-executable programs executed by one or more computing devices and is executed during the production phase.

A set of multimodal data is received (352) and modality feature embeddings are generated (354). For example, and as described in further detail herein with reference to FIG. 2B, the set of inference data 230 is received (e.g., from a MOM platform) and includes image data 230a, ultrasound data 230b, LiDAR data 230c, and UWB data 230d, each of which is representative of a product (e.g., a solar panel) that is undergoing defect detection. The image data 230a is processed through the image feature extraction module 202a, which generates an image feature embedding, the ultrasound data 230b is processed through the ultrasound feature extraction module 202b, which generates an ultrasound feature embedding, the LiDAR data 230c is processed through the LiDAR feature extraction module 202c, which generates a LiDAR feature embedding, and the UWB data 230d is processed through the UWB feature extraction module 202d, which generates an UWB feature embedding.

Modified modality feature embeddings are generated (356) and a multimodal embedding is provided (358). For example, and as described in further detail herein, the image feature embedding is transformed by the image linear projection module 204a′ to a modified image feature embedding, the ultrasound feature embedding is transformed by the ultrasound linear projection module 204b′ to a modified ultrasound feature embedding, the LiDAR feature embedding is transformed by the LiDAR linear projection module 204c′ to a modified LiDAR feature embedding, and the UWB feature embedding is transformed by the UWB linear projection module 204d′ to a modified UWB feature embedding having the common dimension. The modified ultrasound feature embedding, the modified ultrasound feature embedding, the modified LiDAR feature embedding, and the modified UWB feature embedding are provided to the aggregation module 210, which aggregates the modified feature embeddings to provide a multimodal feature embedding (zₘₘ).

A unified cross-modal embedding is provided (360) and is decoded (362). For example, and as described in further detail herein, the multimodal feature embedding (zₘₘ) is provided to the cross-modal transformer 212′, which generates a unified cross-modal embedding (z_{cm}). The unified cross-modal embedding z_{cm} is provided as input to the decoder 214′, which provides output to the classification head 216′ and the regression head 218′. Inference is executed to provide predictions (364). For example, and as described in further detail herein, the classification head 216′ processes the output of the decoder 214′ to provide a predicted class label (yₚ) 222 and the regression head 218′ processes the output of the decoder 214′ to provide a predicted localization (boxₚ). In some examples, the predicted class label (yₚ) indicates a type of a defect that is detected in the product and the predicted localization (boxₚ) provides an indication of a location of the defect on or within the product. In some examples, the predicted localization (boxₚ) is graphically represented on an image of the product (e.g., the image of the image data 230a).

Implementations of the present disclosure provide multiple technical advantages. For example, implementations of the present disclosure provide overcome limitations of unimodal defect detection, such as vision-based defect detection that includes various limitations, including sensitivity to environmental conditions. To overcome this, the multimodal approach of the defect detection system of the present disclosure leverages the strengths of different sensors, enhancing both robustness and adaptability. Further, the defect detection system of the present disclosure resolves discrepancies between modality-specific data from different sensors. M ore particularly, data from different sensors exhibit major discrepancies in terms of scale and value distribution. To address this challenge, implementations of the present disclosure provide feature alignment that maps modality-specific features into a unified feature space, enabling seamless integration and comparison of data from diverse sources.

Implementations of the present disclosure also reduce information loss in feature fusion. M ore particularly, combining modality features in a simplistic manner, such as adding and concatenating, can result in significant information loss due to excessive feature compression. To retain the unique characteristics of each modality during fusion, implementations of the present disclosure provide attention-based cross-modal fusion to ensure that the distinct features of each sensor modality are preserved and effectively leveraged.

As described herein, implementations of the present disclosure provide a unified multimodal visual inspection framework for versatile application scenarios. M ore particularly, traditional visual inspection deep learning frameworks are specifically designed for different scenarios considering various defect types. Implementations of the present disclosure provide a unified framework that can be adapted to different scenarios to inspect various defects. When the framework of the present disclosure is applied to different use cases and previously unseen defects are seen, task-specific, modality-specific sensors can be purposively integrated to effectively capture unique features of new defects and fully utilize the unique features in feature fusion stage to perform visual inspection. M ore plainly stated, sensors of other modalities (e.g., other than image, ultrasound, LiDAR, UWB) that are more capable of sensing new defects can be seamlessly integrated into the defect detection system.

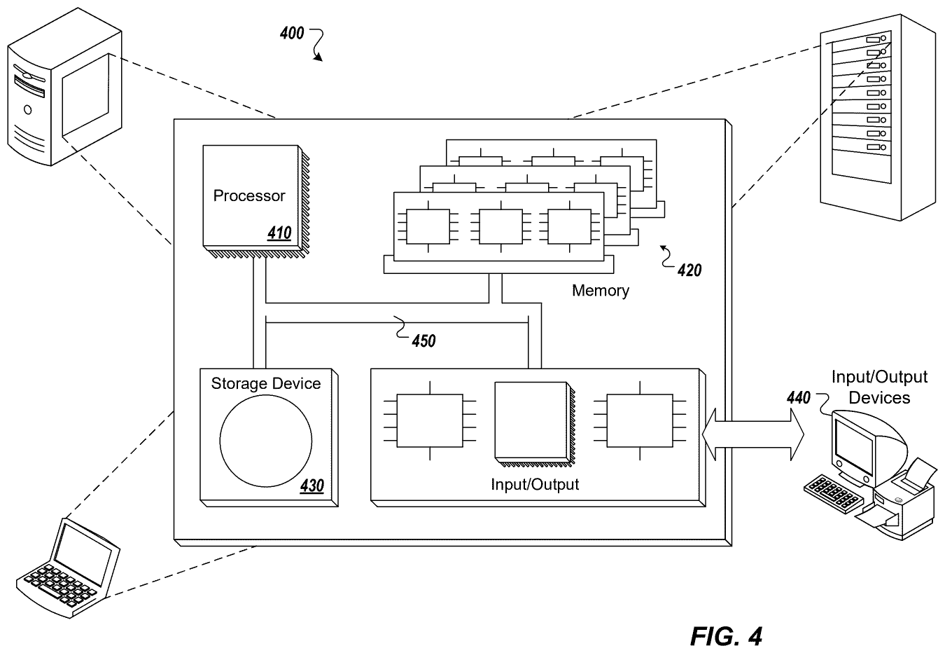

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LA N, a WA N, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for automated visual inspection of products for defect detection, the method being executed by one or more processors and comprising:
receiving a set of multimodal training data comprising a first sub-set of training data of a first modality and a second sub-set of training data of a second modality;
generating a first modality feature embedding from the first sub-set of training data and a second modality feature embedding from the second sub-set of training data;
processing the first modality feature embedding through a first linear projector to provide a first modified modality feature embedding and the second modality feature embedding through a second linear projector to provide a second modified modality feature embedding;
determining a first loss value based on the first modified modality feature embedding and the second modified modality feature embedding;
determining an overall loss value at least partially based on the first loss value; and
adjusting parameters of each of the first linear projector and the second linear projector for an iteration of training based on the overall loss value for feature alignment between the first modality and the second modality.

2. The method of claim 1, further comprising:
aggregating the first modified modality feature embedding and the second modified modality feature embedding to provide a multimodal feature embedding;
generating a unified cross-modal embedding by processing the multimodal feature embedding through a cross-modal transformer; and
determining a set of predictions by processing the unified cross-modal embedding through a decoder, the set of predictions being generated by a classification head and a regression head using output of the decoder.

3. The method of claim 2, further comprising adjusting parameters of each of the cross-modal transformer, the classification head, and the regression head for the iteration of training based on the overall loss value.

4. The method of claim 2, wherein the overall loss value is further determined based on a classification loss and a regression loss.

5. The method of claim 1, wherein the first loss value is calculated as a maximum mean discrepancy (MMD) loss that is determined based on differences between each of the first modified modality feature embedding and an average modified modality feature embedding, and the second modified modality feature embedding and the average modified modality feature embedding.

6. The method of claim 1, wherein the first linear projector modifies a first dimension of the first modality feature embedding to provide the first modified modality feature embedding in a common dimension, and the second linear projector modifies a second dimension of the second modality feature embedding to provide the second modified modality feature embedding in the common dimension.

7. The method of claim 1, wherein the first modality comprises an image modality and the second modality comprises one of an ultrasound modality, a light detection and ranging (LiDAR) modality, and an ultrawide band (UWB) modality.

8. A non-transitory computer-readable storage medium coupled to one or more processors and having instructions stored thereon which, when executed by the one or more processors, cause the one or more processors to perform operations for automated visual inspection of products for defect detection, the operations comprising:
receiving a set of multimodal training data comprising a first sub-set of training data of a first modality and a second sub-set of training data of a second modality;
generating a first modality feature embedding from the first sub-set of training data and a second modality feature embedding from the second sub-set of training data;
processing the first modality feature embedding through a first linear projector to provide a first modified modality feature embedding and the second modality feature embedding through a second linear projector to provide a second modified modality feature embedding;
determining a first loss value based on the first modified modality feature embedding and the second modified modality feature embedding;
determining an overall loss value at least partially based on the first loss value; and
adjusting parameters of each of the first linear projector and the second linear projector for an iteration of training based on the overall loss value for feature alignment between the first modality and the second modality.

9. The non-transitory computer-readable storage medium of claim 8, wherein operations further comprise:
aggregating the first modified modality feature embedding and the second modified modality feature embedding to provide a multimodal feature embedding;
generating a unified cross-modal embedding by processing the multimodal feature embedding through a cross-modal transformer; and
determining a set of predictions by processing the unified cross-modal embedding through a decoder, the set of predictions being generated by a classification head and a regression head using output of the decoder.

10. The non-transitory computer-readable storage medium of claim 9, wherein operations further comprise adjusting parameters of each of the cross-modal transformer, the classification head, and the regression head for the iteration of training based on the overall loss value.

11. The non-transitory computer-readable storage medium of claim 9, wherein the overall loss value is further determined based on a classification loss and a regression loss.

12. The non-transitory computer-readable storage medium of claim 8, wherein the first loss value is calculated as a maximum mean discrepancy (MMD) loss that is determined based on differences between each of the first modified modality feature embedding and an average modified modality feature embedding, and the second modified modality feature embedding and the average modified modality feature embedding.

13. The non-transitory computer-readable storage medium of claim 8, wherein the first linear projector modifies a first dimension of the first modality feature embedding to provide the first modified modality feature embedding in a common dimension, and the second linear projector modifies a second dimension of the second modality feature embedding to provide the second modified modality feature embedding in the common dimension.

14. The non-transitory computer-readable storage medium of claim 8, wherein the first modality comprises an image modality and the second modality comprises one of an ultrasound modality, a light detection and ranging (LiDAR) modality, and an ultrawide band (UWB) modality.

15. A system, comprising:
a computing device; and
a computer-readable storage device coupled to the computing device and having instructions stored thereon which, when executed by the computing device, cause the computing device to perform operations for automated visual inspection of products for defect detection, the operations comprising:
receiving a set of multimodal training data comprising a first sub-set of training data of a first modality and a second sub-set of training data of a second modality;
generating a first modality feature embedding from the first sub-set of training data and a second modality feature embedding from the second sub-set of training data;
processing the first modality feature embedding through a first linear projector to provide a first modified modality feature embedding and the second modality feature embedding through a second linear projector to provide a second modified modality feature embedding;
determining a first loss value based on the first modified modality feature embedding and the second modified modality feature embedding;
determining an overall loss value at least partially based on the first loss value; and
adjusting parameters of each of the first linear projector and the second linear projector for an iteration of training based on the overall loss value for feature alignment between the first modality and the second modality.

16. The system of claim 15, wherein operations further comprise:
aggregating the first modified modality feature embedding and the second modified modality feature embedding to provide a multimodal feature embedding;
generating a unified cross-modal embedding by processing the multimodal feature embedding through a cross-modal transformer; and
determining a set of predictions by processing the unified cross-modal embedding through a decoder, the set of predictions being generated by a classification head and a regression head using output of the decoder.

17. The system of claim 16, wherein operations further comprise adjusting parameters of each of the cross-modal transformer, the classification head, and the regression head for the iteration of training based on the overall loss value.

18. The system of claim 16, wherein the overall loss value is further determined based on a classification loss and a regression loss.

19. The system of claim 15, wherein the first loss value is calculated as a maximum mean discrepancy (MMD) loss that is determined based on differences between each of the first modified modality feature embedding and an average modified modality feature embedding, and the second modified modality feature embedding and the average modified modality feature embedding.

20. The system of claim 15, wherein the first linear projector modifies a first dimension of the first modality feature embedding to provide the first modified modality feature embedding in a common dimension, and the second linear projector modifies a second dimension of the second modality feature embedding to provide the second modified modality feature embedding in the common dimension.
